(19) United States
(12) Patent Application Publication
(10) Pub. No.: US 2007/0056897 A1
(43) Pub. Date: Mar. 15, 2007

(54) Non-metallic filter assembly and method of producing the same

(75) Inventors: Arun K. Bhardwaj, Gurgaon (IN); Robert E. Semrad, Fayetteville, NC (US)

Correspondence Address: CROWELL & MORING LLP;INTELLECTUAL PROPERTY GROUP, P.O. BOX 14300, WASHINGTON, DC, 20044-4300, US

(73) Assignee: Arvin Technologies, Inc.

(21) Appl. No.: 11/225,350

(22) Filed: Sep. 13, 2005

(51) Int. Cl. B01D 35/28; B01D 27/06

(52) U.S. Cl. 210/437; 210/493.1; 210/493.2

(57) ABSTRACT

A non-metallic filter assembly including a non-metallic canister having a closed end, an open end, and defining a hollow. A non-metallic bottom assembly is mounted on the open end of the canister and a non-metallic element assembly is disposed within the hollow of the canister. The element assembly includes a pleated media having a first end and a second end, each of which is sealed along an interior surface of each of the ends. Alternatively, each of first and second ends may be sealed by fixing the ends in a mold. The bottom assembly includes an integrally formed center tube which extends into the hollow of the canister and about which the pleated media is disposed. The closed end of the canister includes radially extending, spaced-apart ribs projecting into the hollow and supporting the second end of element assembly.

### BACKGROUND OF THE INVENTION

1. Field of the Invention

The present invention relates to filters, particularly non-metallic filter assemblies.

2. Description of the Related Art

Vehicle filtration systems, such as air filters, oil filters and fuel filters, commonly include replaceable, disposable filter assemblies. Oil and fuel filter assemblies, in particular, often comprise a substantial number of metal parts that must be assembled. For example, replaceable spin-on oil filter assemblies, generally, include a metal canister having an open end and a closed end, a filter element assembly disposed within the metal canister, and a metal case bottom assembly seamed to the open end of the canister.

The canister is typically made from sheet metal and often includes gripping portions pressed into the closed end of the can. The filter element assembly typically includes a pleated paper element or media arranged in a cylindrical shape with its vertical ends joined together by a metal clip. Each of the horizontal ends of the cylindrically arranged media are affixed to a metal end cap using an adhesive such as plastisol, which is typically cured in an oven. A separate center tube, which is typically metallic, is captured between the metal end caps and within a central aperture provided by the pleated paper element.

The case bottom assembly ordinarily includes a retainer plate and a cover plate, both comprised of sheet metal, and which are welded or clinched together. The cover is tapped to create a threaded outlet hole for mounting the filter assembly on, and communicating oil through the hollow engine stud. Inlet holes are also stamped or drilled into the cover plate. The retainer plate is seamed to the opened of the canister.

The spin-on oil filter assembly often includes additional metal components, such as an element guide for positioning the element assembly within the canister, and a pressure relief valve for bypassing the element when it becomes clogged. Finally, the filter assembly, particularly the canister, is typically painted and labeled, which involves metal surface pretreatment, painting and curing. Recycling of these metal-containing filters can be expensive because it requires collection, handling and treatment of the used filters.

Recent attempts have been made to reduce or eliminate the metal parts of a spin-on oil filter. For example, prior art non-metallic filter assemblies have employed the same number of components thereby failing to take advantage of the benefits provided by the non-metallic material. Separate center tubes are still employed, and element guides are often still used to locate the filter element assembly to a desired position. As a result, manufacturing efficiency has not been improved appreciably. Prior art non-metallic filter assemblies have not been commercially successful, and therefore, a need remains for a filter assembly that has no metallic parts, thereby reducing the cost of manufacture and assembly.

### SUMMARY OF THE INVENTION

The present invention provides a non-metallic filter assembly that includes a non-metallic canister having a closed end, an open end, and defining a hollow. A non-metallic bottom assembly is mounted on the open end of the canister, and a non-metallic filter element assembly is arranged within the hollow of the canister. The filter element assembly includes a pleated media having a first end and a second end. In one example, the pleated media is sealed at each of the first and second ends extending along an interior surface of each of the first and second ends. The non-metallic bottom assembly includes an integrated center tube that extends through a central aperture of the filter element assembly. A non-metallic bypass valve is arranged at a free end of the center tube.

The closed end curves inward into the hollow and includes a plurality of radially extending, spaced-apart flanges projecting into the hollow. A non-metallic bottom assembly is mounted on the open end of the canister and a non-metallic element assembly is disposed within the hollow of the canister. In one example, the second end is supported by and abuts the plurality of flanges, and the free end of the center tube is arranged interiorly of the flanges so that the flanges extend radially outward relative to the free end. The curved, closed end and flanges form sediment collection pockets.

The present invention further provides a method for producing a non-metallic filter assembly including the step of molding a non-metallic canister having a concave closed end, an open end, and defining a hollow. The closed end defines a plurality of radially extending, spaced-apart flanges projecting into the hollow. The method also includes the steps of pleating an element media and sealing both a first end and a second end of the media. A non-metallic bottom assembly is provided having a thread portion and an integrally formed center tube extending therefrom. The element media is mounted about the center tube of the bottom assembly. The bottom assembly is secured onto the open end of the canister such that the center tube and element assembly are disposed within the canister.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a sectional view of a filter assembly according to the present invention;

FIG. 2 is a perspective view of the canister of the filter assembly in FIG. 1;

FIG. 3 is a perspective view of a bottom assembly of the filter assembly in FIG. 1;

FIG. 4 is another perspective view of a bottom assembly of the filter assembly in FIG. 1;

FIG. 5 is a perspective view of the element assembly of the filter assembly in FIG. 1;

FIGS. 6a-6d are illustrations of the steps of producing the pleated media of an element assembly according to one embodiment of the present invention; and

FIGS. 7a-7c are illustrations of the steps of producing the pleated media of an element assembly according to another embodiment of the present invention.

### DETAILED DESCRIPTION

The embodiments hereinafter disclosed are not intended to be exhaustive or to limit the invention to the precise forms disclosed in the following description. Rather the embodiments are chosen and described so that others skilled in the art may utilize its teachings.

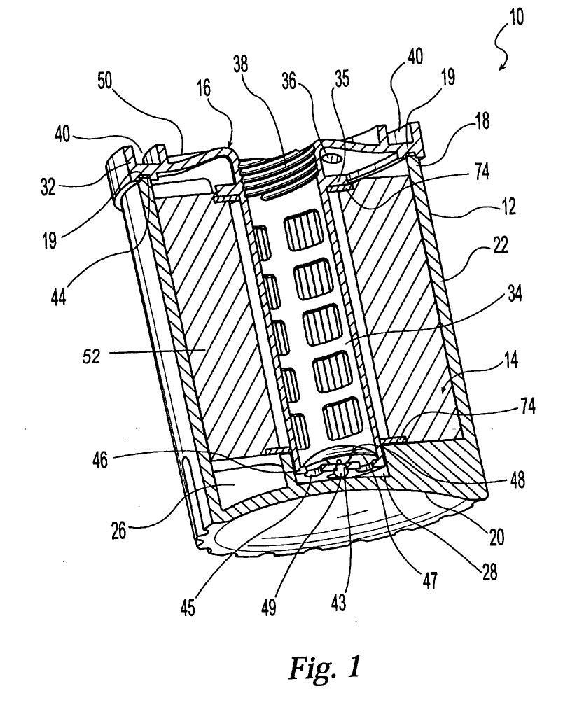

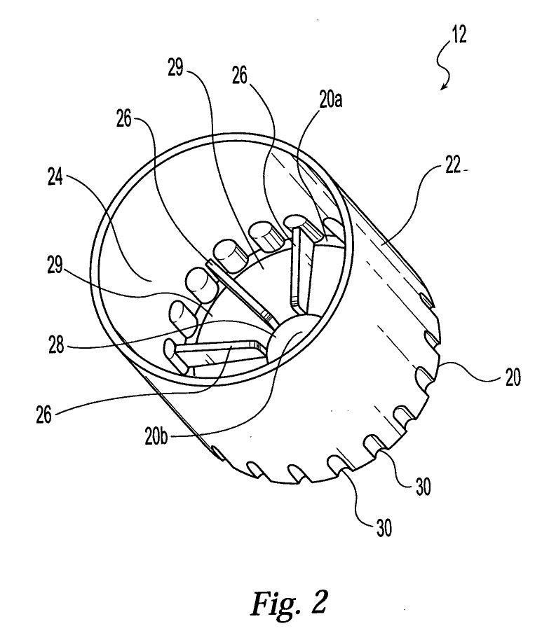

FIG. 1 illustrates an oil filter assembly 10 having no metallic parts according to the present invention. Oil filter assembly 10, generally, includes canister 12 having an open end 18, filter element assembly 14 disposed within canister 12, and bottom assembly 16 mounted on open end 18 of canister 12. Referring now to FIGS. 1 and 2, canister 12 is comprised of a molded non-metallic material, such as plastic, polyurethane or rubber, that is capable of withstanding the temperatures of and the heat created by the engine, its related systems, and the oil. Canister 12 may also be molded in a particular color, thereby eliminating the painting process. Alternatively, canister 12 may be transparent or translucent to allow a user to observe the filtration process.

Canister 12 includes closed end 20 and cylindrical wall 22, which together define hollow 24. Canister 12 may be molded to include a plurality of gripping depressions 30 defined in cylindrical wall 22 near closed end 20. To provide added strength to the canister 12, closed end 20 may optionally have a concave shape that curves inward into hollow 24, which provides dimensionally stability to the closed end 20 under pressure. Closed end 20 also has a plurality of radially extending, spaced apart flanges or ribs 26 that protrude into hollow 24. As best illustrated in FIG. 2, each flange 26 extends radially from a point spaced from the center 20b of closed end 20 to the outer perimeter 20a of closed end 20, thereby forming seat 28 at the center 20b of the interior surface of closed end 20. Sediment collection pockets 29 are formed by and between adjacent flanges 26. Due to the concave shape of closed end 20, pockets 29 are progressively deeper approaching the outer perimeter of closed end 20. Pockets 29 collect and hold sediment matter thereby providing additional filter capacity.

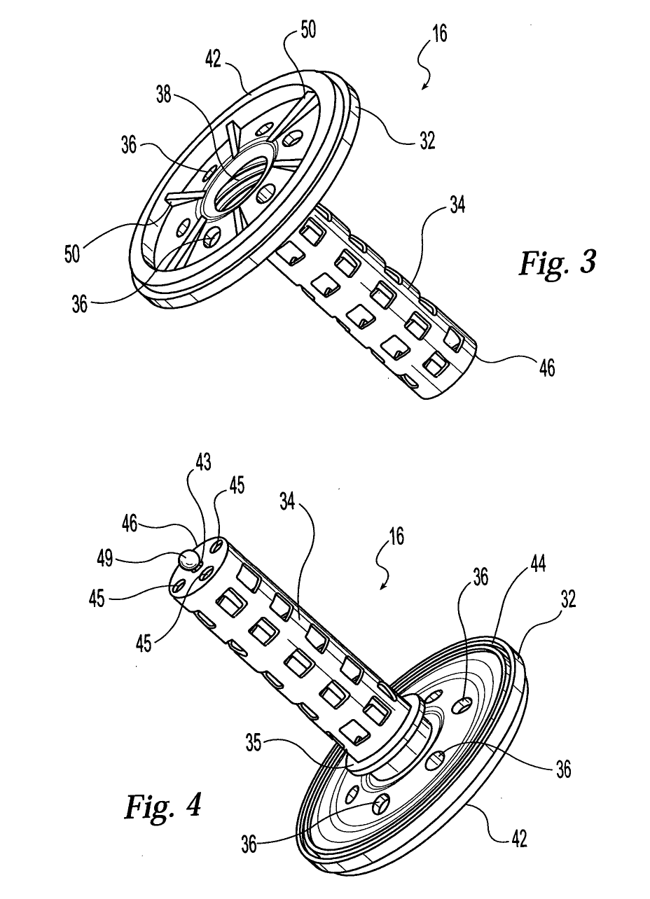

Referring now to FIGS. 1, 3 and 4, bottom assembly 16 is comprised of a molded non-metallic material, such as a plastic, polyurethane or rubber, that is capable of withstanding the temperatures of and the heat created by the engine and the oil. Bottom assembly 16 includes a plate portion 32 and a perforated center tube 34 extending from and integrally formed with plate portion 32. Plate portion 32 includes a plurality of inlet holes 36, which communicate oil from the engine (not shown) to hollow 24 of canister 12. Plate portion 32 also includes outlet hole 38, which is in communication with the interior of center tube 34 and communicates oil from the interior of center tube 34 to the engine. Outlet hole 38 is threaded for mounting filter assembly 10 onto a threaded hollow bolt (not shown) of an engine.

Plate portion 32 further includes radial support ribs 50 defined on the exterior surface of plate portion 32. Ribs 50 reinforce plate portion 32 and provide added strength to prevent bending or deflection of plate portion 32 to better ensure dimensional stability so that a good seal is maintained. Bottom assembly 16 also includes circumferentially extending exterior groove 40 defined on the exterior surface of plate portion 32. Exterior groove 40 receives gasket 42, which seals oil filter assembly 10 to the engine. Alternatively, gasket 42 may be molded in place on plate portion 32 during the formation of bottom assembly 16. Bottom assembly 16 also includes circumferentially extending interior groove 44 defined on the interior surface of plate portion 32. Bottom assembly 16 is mounted on the open end 18 of canister 12 by fitting an open edge 19 of cylindrical wall 22 into interior groove 44 and sealingly fixing wall 22 within interior groove 44 using any suitable fixing means, such as spin welding, vibration welding or heat resistant adhesive. Such assembly process reduces the need for seaming equipment. Furthermore, bottom assembly 16 may be molded to include inlet holes 36, outlet hole 38, ribs 50, and grooves 40, 44, thereby eliminating the need for pressing, tapping and/or clinching.

Center tube 34 includes free end 46 opposite plate portion 32 and positioned adjacent closed end 20 of canister 12. When bottom assembly 16 is mounted on canister 12, center tube 34 extends into hollow 24 of canister 12 and free end 46 of center tube 34 fits within seat 28 of closed end 20. A step or stop flange 35 extends radially about center tube 34 near plate portion 32 and provides a supporting surface for filter element assembly 14. A non-metallic anti-drain back valve (not shown for clarity) may be supported near center tube 34 near the plate portion 32 to prevent dirty oil from flowing past the inlet holes 36.

The free end 46 is a received by the flanges 26, which locate the center tube 34, thereby eliminating the need for the prior art element guide.

Bottom assembly 16 also includes a non-metallic bypass valve 48 mounted in the free end 46 of center tube 34, as seen in FIG. 1. Bypass valve 48 is made of a resilient material, such as plastic, polyurethane or rubber that is capable of withstanding the heat of the engine and oil. Free end 46 of center tube 34 includes a plurality of bypass openings 45 and a valve mounting hole 43. Bypass valve 48 includes a snap-head fastener portion 49, which is received in hole 43 to mount bypass valve 48 to free end 46 of center tube 34. Bypass valve 48 also includes resilient flange or flap 47 which sealingly covers bypass openings 45 during normal operating conditions. During high pressure conditions, such as when media 52 becomes clogged, flap 47 deflects away from openings 45 to allow oil to flow into center tube 34.

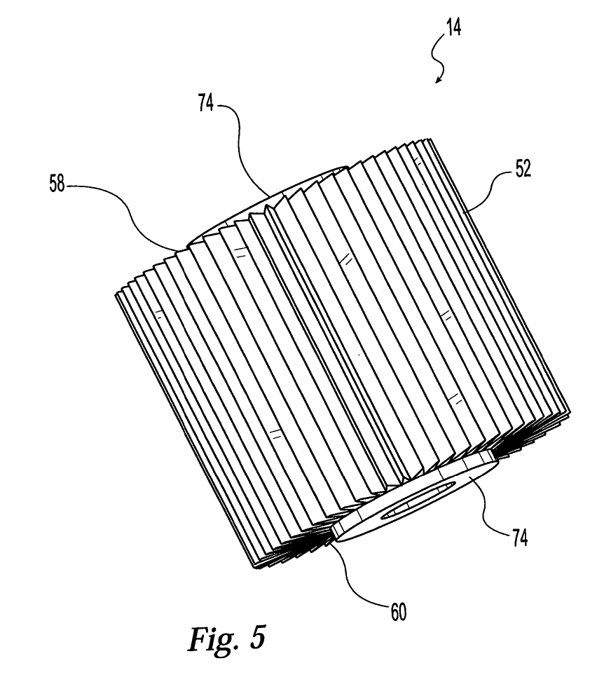

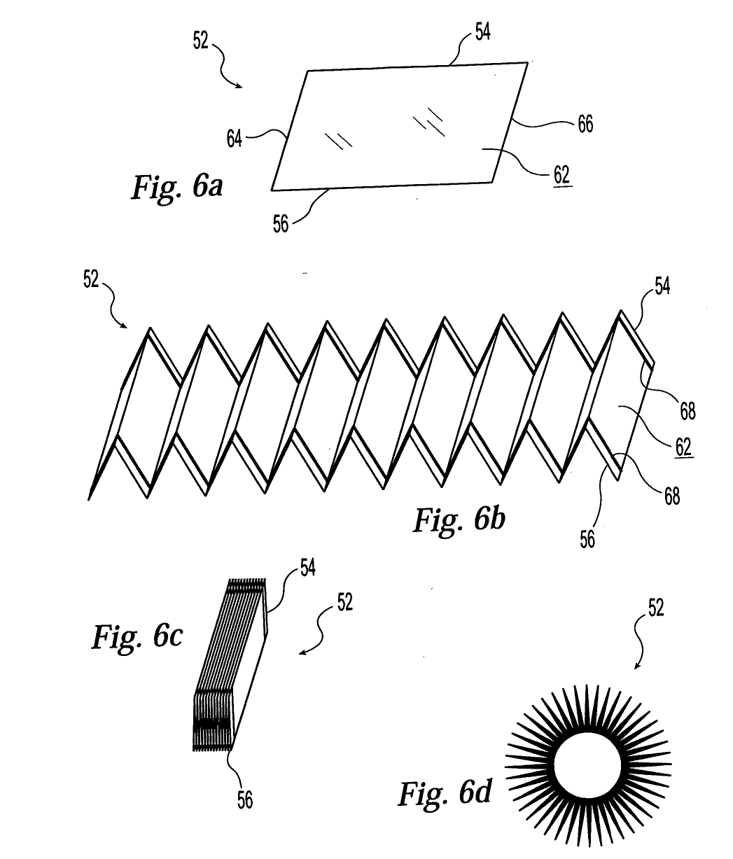

Turning now to FIGS. 1, 5 and 6a, element assembly 14 includes paper element or media 52. Media 52 is made from a substantially rectangular sheet having first and second ends 54, 56; first and second sides 64, 66; and inner surface 62, as shown in FIG. 6a. First and second ends 54, 56 of media 52 are sealed with respect to hollow 24 of canister 12 by applying a bead of adhesive 68 to the inner surface 62 of media 52, as shown in FIG. 6b, and then pleating and compressing the media on its pleats until the adhesive is cured or set, as shown in FIG. 6c. First and second sides 64, 66 are then joined together with adhesive to form cylindrical media 52 shown in FIGS. 5 and 6d. Rather than sealing the first and second ends 54, 56 of media 52 using a bead of adhesive, first and second ends 54, 56 may be sealed by fixing ends 54, 56 in a polyurethane mold. A gasket 74 may be provided by securing a felt material, for example, to edges 58, 60, as shown in FIG. 5.

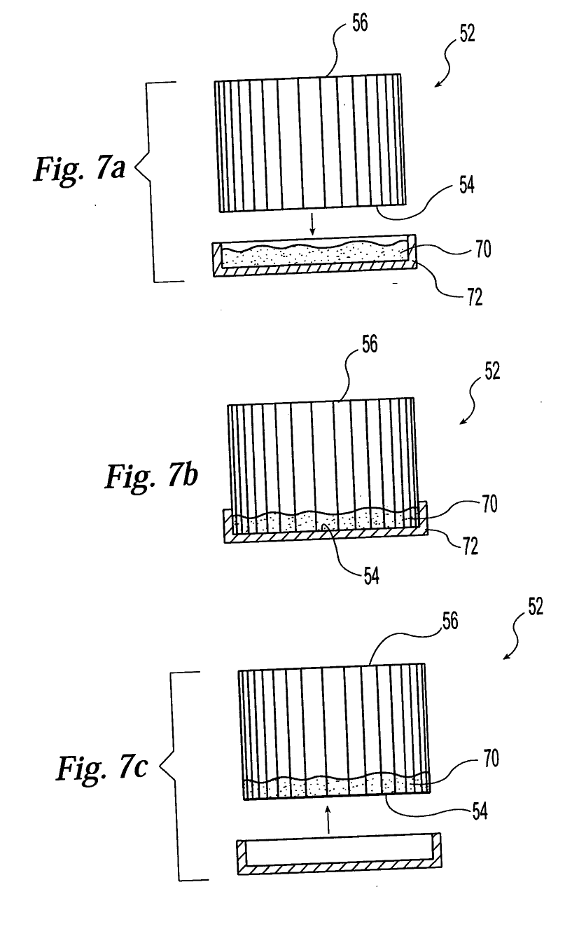

As shown in FIGS. 7a-7c, a polyurethane 70, such as polyurethane adhesive or elastomer, is injected into a mold 72 to provide an alternative gasket. First end 54 of media 52 is inserted into polyurethane 70 and the polyurethane 70 is cured into a slightly flexible foam-like material, either by thermoset or by air dry. Media 52 is then removed from mold 72 with the first end 54 sealed in the foam-like polyurethane. The process is repeated for second end 56 producing a pleated media sealed at each end with polyurethane 70.

As shown in FIG. 1, cylindrical media 52 is slidingly mounted onto center tube 34. The gasket 74, which is fixed to each of the edges 58, 60 of first and second ends 54, 56, provides a seal between media 52 and center tube 34. First end 54 of media 52 is supported on stop flange 35 of center tube 34. Second end 56 of media 52 is supported by flanges 26 of closed end 20 of canister 12, thereby eliminating the need for an element guide and reducing the assembly process. Because oil filter assembly 10 includes no metallic parts, the filter assembly may be incinerated after use. Disposal of the oil filter by incineration reduces the expense of recycling and is more environmentally friendly.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A non-metallic filter assembly comprising:
a non-metallic canister having a closed end and an open end, and defining a hollow;
a non-metallic bottom assembly mounted on said open end of said non-metallic canister, said non-metallic bottom assembly having a plate portion with a hole, and said non-metallic bottom assembly including a center tube integral with said non-metallic bottom assembly and extending axially from said plate portion and in communication with said hole; and
a non-metallic element assembly disposed within said hollow of said non-metallic canister and including a pleated media having a first end and a second end, said pleated media arranged about the center tube.

2. The non-metallic filter assembly of claim 1 wherein said pleated media is sealed at each of said first and second ends along an interior surface of each of said first and second ends of said pleated media, each of said first and second ends having an edge, said edge of each of said first and second ends being exposed to said hollow.

3. The non-metallic filter assembly of claim 2 wherein said non-metallic element assembly further includes a non-metallic gasket mounted on each of said first and second ends to provide a seal between said pleated media and said center tube.

4. The non-metallic filter assembly of claim 2 wherein said center tube has a free end disposed adjacent said closed end of said non-metallic canister, said center tube including a non-metallic bypass valve mounted at said free end.

5. The non-metallic filter assembly of claim 2 wherein said center tube includes a stop flange, said edge of said first end of said pleated media supported on said stop flange.

7. The non-metallic filter assembly of claim 1 wherein said closed end of said non-metallic canister has a concave shape wherein said closed end curves inward into said hollow.

6. The non-metallic filter assembly of claim 2 wherein said closed end of said non-metallic canister includes radially extending, spaced-apart ribs projecting into said hollow, said edge of said second end of said pleated media directly abutting said radially extending, spaced apart ribs, and said radially extending, spaced apart ribs forming a sediment collection pocket between adjacent ribs.

8. The non-metallic filter assembly of claim 6 wherein said center tube includes a free end; and wherein said radially extending, spaced apart ribs extend from a point spaced from a center of said closed end to an outer perimeter of said closed end, said radially extending, spaced apart ribs thereby forming a seat at said center of said closed end, said free end of said center tube positioned in said seat.

9. The non-metallic filter assembly of claim 1 wherein said non-metallic bottom assembly includes an interior groove defined on an interior surface of said non-metallic bottom assembly, said open end of said non-metallic canister being received in said interior groove.

10. A non-metallic filter assembly comprising:
a non-metallic canister having a closed end and an open end, and defining a hollow, said closed end including a plurality of radially extending, spaced-apart ribs projecting into said hollow;
a non-metallic bottom assembly mounted on said open end of said non-metallic canister; and
a non-metallic element assembly disposed within said hollow of said non-metallic canister and having a first end, a second end, and a pleated media extending between said first and second ends, said second end abutting said plurality of radially extending, spaced apart ribs.

11. The non-metallic filter assembly of claim 10 wherein said non-metallic element assembly is sealed at each of said first and second ends along an interior surface of said pleated media at each of said first and second ends.

12. The non-metallic filter assembly of claim 10 wherein each of said first and second ends includes a polyurethane gasket.

13. The non-metallic filter assembly of claim 10 wherein said non-metallic bottom assembly includes an integrally formed center tube extending into said hollow of said non-metallic canister and having a free end disposed adjacent said closed end of said non-metallic canister.

14. The non-metallic filter assembly of claim 13 wherein said plurality of radially extending, spaced apart ribs extend from a point spaced from a center of said closed end to an outer perimeter of said closed end, said plurality of radially extending, spaced apart ribs thereby forming a seat at said center of said closed end, said free end of said integrally formed center tube being positioned in said seat.

15. The non-metallic filter assembly of claim 13 wherein said plurality of radially extending, spaced apart ribs form sediment collection pockets between adjacent ribs.

16. The non-metallic filter assembly of claim 13 wherein said integrally formed center tube includes a non-metallic bypass valve mounted at said free end.

17. A method for producing a non-metallic filter assembly comprising the steps of:
molding a non-metallic canister having a closed end and an open end, and defining a hollow, the closed end curving inward into the hollow, the closed end defining a plurality of radially extending, spaced-apart ribs projecting into the hollow;
pleating an element media;
sealing both a first end and a second end of the element media;
molding a non-metallic bottom assembly having a plate portion and an integrally formed center tube extending therefrom;
mounting the element media about the integrally formed center tube; and
securing the non-metallic bottom assembly onto the open end of the non-metallic canister such that the integrally formed center tube and element media are disposed within the non-metallic canister.

18. The method of claim 17 wherein said step of sealing both a first end and a second end of the element media includes applying a bead of adhesive along an interior surface of the element media at each of the first and second ends.

19. The method of claim 17 wherein said step of sealing both a first end and a second end of the media includes fixing an edge of each of the first and second ends in a mold.

20. The method of claim 17 wherein the integrally formed center tube includes a free end opposite the plate portion and further including the step of mounting a non-metallic bypass valve in the free end of the integrally center tube.
